(19) United States
(12) Patent Application Publication
(10) Pub. No.: US 2015/0227939 A1
(43) Pub. Date: Aug. 13, 2015

(54) AFTER-SALES SERVICE COMMUNICATION ESTABLISHMENT METHOD AND SYSTEM THEREOF

(71) Applicants: Nen-Fu HUANG, Hsinchu (TW); Wei-Kuan SHIH, Hsinchu (TW); Yi-Ju LIAO, Hsinchu (TW)

(72) Inventors: Nen-Fu HUANG, Hsinchu (TW); Wei-Kuan SHIH, Hsinchu (TW); Yi-Ju LIAO, Hsinchu (TW)

(21) Appl. No.: 14/305,650

(22) Filed: Jun. 16, 2014

(30) Foreign Application Priority Data
Feb. 11, 2014 (TW) 103104349

(51) Int. Cl. G06Q 30/00; G06F 3/0481; H04M 1/725; G06F 3/0484

(52) U.S. Cl. CPC G06Q 30/016; G06F 3/04842; G06F 3/04817; H04M 1/72583

(57) ABSTRACT

The present disclosure discloses an after-sales communication establishment method and system thereof. The method comprises the steps as below. A network address and a product serial number are obtained by using a mobile device to detect an identification unit of the product. A cloud server is connected and an application located the cloud server is downloaded to the mobile device via the network address. The application is executed for transmitting the id number of the mobile device and the product serial number to a communication server. A corresponding after-sales terminal respect to the product serial number is determined by the communication server. Then, based on the id number, a communication between the after-sales terminal and the mobile device is established by the communication server. By the after-sales communication establishment method and system thereof, the requirement of manpower is reduced and the approval rating is raised.

### CROSS-REFERENCE TO RELATED APPLICATION

This application claims the benefit of Taiwan Intellectual Property Office Application No. 103104349, filed on Feb. 11, 2014, in the State Intellectual Property Office, the disclosure of which is incorporated herein its entirety by reference.

### FIELD OF THE INVENTION

The present disclosure relates to an after-sales service communication establishment method and system thereof, in particular to a communication establishment method capable of automatically determining a service dedicated line corresponding to the product.

### BACKGROUND OF THE INVENTION

Apart from the quality and price of a product, an after-sales service which the product provides itself is also served as one of important factors for consumer. When the product goes with something wrong or the usage thereof has problem, how to contact with the professional service personnel through the most convenient and effective way will influence consumer's intention while purchasing that product.

At present, the most common after-sales service can generally be divided into two parts. One is that consumer communicates with the company via a dedicated telecommunication line and the other is via on-line real-time communication by internet; the former has advantage of directly communicating by audio, the latter provides the consumer with a network platform where the counseling can be obtained. However, the deficiency of the former part is that the dedicated telecommunication line is usually a representative number and the consumer often contacts to the professional personnel by repeatedly transferring which is time-consuming to the user and leads to burden of manpower; moreover, the counseling via network is not as convenient as using audio.

In view of the preceding defects, the inventor of the present disclosure designs an after-sales service communication establishment method and system thereof to overcome the obstacle to the deficiency of the current technology and further to increase the industrial applicability.

### SUMMARY OF THE INVENTION

The aspect of the embodiment of the present disclosure directs to an after-sales service communication establishment method and system thereof which is able to transform the after-sales service provided by manufacturer into an automatic system so as to reduce the cost.

The aspect of the embodiment of the present disclosure directs to an after-sales service communication establishment method and system thereof which enables the client to contact with the after-sales service personnel directly without transferring, so as to promote the service and raise the approval rating.

According to the aforementioned purpose, the present disclosure provides an after-sales service communication establishment method which comprises the steps of: using a mobile device to detect an identification unit of a product to obtain a network address and a product serial number; connecting to a cloud server via the network address to download an application located at the cloud server to the mobile device; executing the application for transmitting an id number of the mobile device and the product serial number to a communication establishment server; determining a corresponding after-sales service terminal with respect to the product serial number by the communication establishment server; and establishing a communication between the after-sales service terminal and the mobile device by the communication establishment server based on the id number.

Preferably, the after-sales service communication establishment method further comprises steps of using an application to generate a shortcut icon displayed on a screen of the mobile device after the application is installed in the mobile device; executing the application by clicking the shortcut icon.

Preferably, the mobile device comprises positioning information, and the positioning information may be transmitted to the communication establishment server and the communication establishment server further determines the after-sales service terminal according to the positioning information.

Preferably, an image of the identification unit is captured and the network address and the product serial number may be analyzed by an image capture module of the mobile device, or may be obtained by sensing the identification unit by a sensing module of the mobile device.

Preferably, the identification unit may comprise letters, images, 2D barcodes and QR codes printed or stuck on the product, or NFC sensing chip and RFID chip arranged in the product.

Preferably, the after-sales service terminal may be a dedicated line of professional service personnel who is responsible for the product.

Preferably, a communication between the after-sales service terminal and the mobile device may be a consumer toll-free call.

According to the aforementioned purpose, the present disclosure further provides an after-sales service communication establishment system which may comprise: a cloud server comprising a service program, and the cloud server providing the application for being downloaded to the mobile device based on a connection request of the mobile device; a communication establishment server receiving a communication request, a product serial number of the application installed in the mobile device, and an id number of the mobile device; the communication establishment server determining a corresponding after-sales service terminal with respect to the product serial number and establishing a communication between the mobile device and the after-sales service terminal based on the id number.

Preferably, a shortcut icon is generated on a screen of the mobile device when the application is installed in the mobile device and the application is executed by clicking the shortcut icon.

Preferably, the communication establishment server may further receive positioning information transmitted by the mobile device and may determine the after-sales service terminal according to the positioning information.

### BRIEF DESCRIPTION OF THE DRAWINGS

Hereinafter, embodiments of the present disclosure will be described in detail with reference to the accompanying drawings so that those skilled in the art to which the present disclosure pertains can realize the present disclosure, wherein:

FIG. 1 is a block diagram of an embodiment of an after-sales service communication establishment system according to the present disclosure.

FIG. 2 is the first schematic diagram of the first embodiment of an after-sales service communication establishment system according to the present disclosure.

FIG. 3 is the second schematic diagram of the first embodiment of an after-sales service communication establishment system according to the present disclosure.

FIG. 4 is the third schematic diagram of the first embodiment of an after-sales service communication establishment system according to the present disclosure.

FIG. 5 is a flow chart of the second embodiment of an after-sales service communication establishment method according to the present disclosure.

### DETAILED DESCRIPTION OF THE PREFERRED EMBODIMENTS

As used herein, the term “and/or” includes any and all combinations of one or more of the associated listed items. Expressions such as “at least one of,” when preceding a list of elements, modify the entire list of elements and do not modify the individual elements of the list.

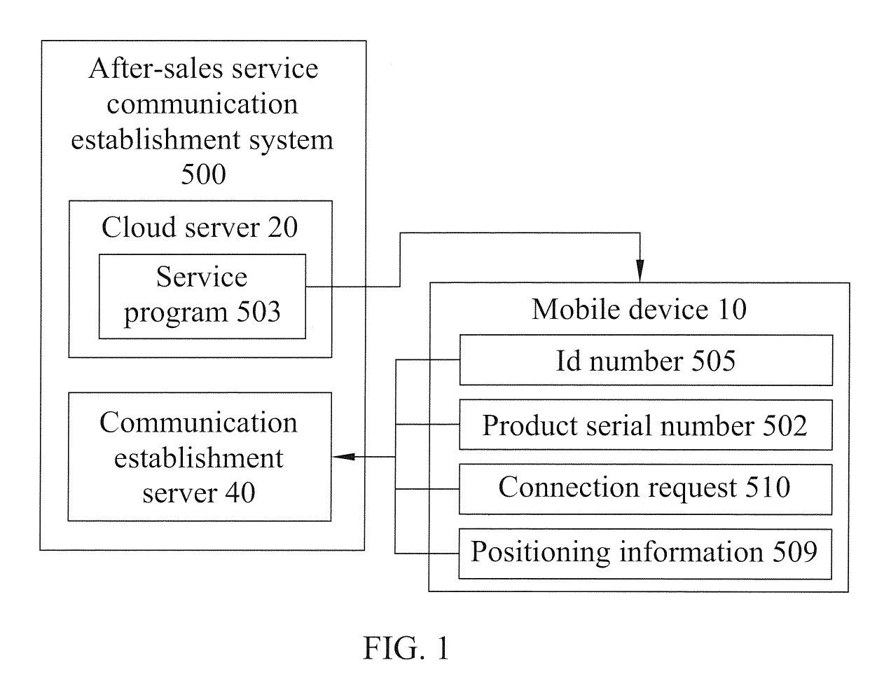

Please refer to FIG. 1 which is a block diagram of an embodiment of an after-sales service communication establishment system according to the present disclosure. An after-sales service communication establishment system 500 of the present disclosure comprises a cloud server 20 and a communication establishment server 40. In implementation, the cloud server 20 and the communication establishment server 40 can be arranged on a working station, a server or a desk-top computer, or on the different working stations, servers or desk-top computers. The cloud server 20 comprises a service program 503, and the service program 503 is a web application. The cloud server 20 provides the service program 503 for being downloaded to a mobile device 10 according to a connection request of the mobile device 10. Preferably, the mobile device 10 comprises tablet, smartphone and laptop.

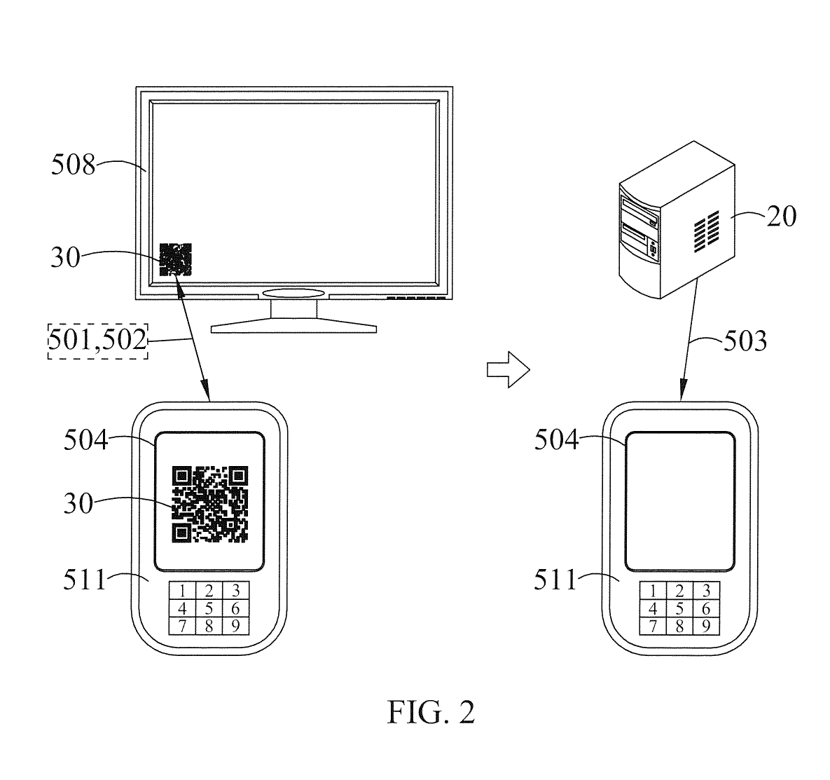

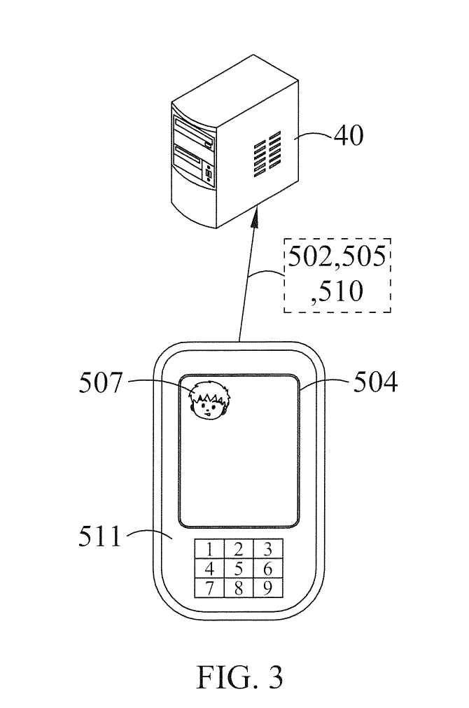

When the service program 503 is installed in the mobile device 10, the service program 503 instantly generates a shortcut icon 507 on a screen 504 of the mobile device 10. The shortcut icon 507 and the screen 504 are shown in FIG. 3. The service program 503 can be executed by clicking the shortcut icon 507. The shortcut icon 507 comprises a figure of an after-sales service personnel or a logo figure of firm. After the shortcut icon 507 is clicked, the communication establishment server 40 can receive a connection request 510 of the service program 503 installed in the mobile device 10, a product serial number 502 and an id number 505 of the mobile device 10. The product serial number 502 can be obtained by using the mobile device 10 to detect an identification unit 30 (not shown in FIG. 1 but in FIG. 2) of a product 508 (not shown in FIG. 1 but in FIG. 2) and the identification unit 30 comprises QR codes, letters and 2D barcodes printed or stuck on the product, or NFC sensing chips and RFID chips arranged in the product 508. The detecting method may be differentiated according to different types of the identification unit 30. For example, an image of the identification unit 30 is captured and analyzed by an image capture module of the mobile device 10, or can be obtained by sensing the identification unit 30 by a sensing module. The communication establishment server 40 determines a corresponding after-sales terminal 506 (not shown in FIGS.) with respect to the product serial number 502 and establishes the communication between the mobile device 10 and the after-sales service terminal 506 based on the id number 505 of the mobile device 10, such as a telephone number.

In addition, the communication establishment server 40 can further receive positioning information 509 transmitted by the mobile device 10, and determines the after-sales service terminal 506 according to the positioning information 509. For example, when the positioning information 509 shows a location of Hsinchu County, Taiwan Province, if the after-sales service terminal 506 of the product 508 is also provided in the same location, the communication establishment server 40 can therefore determine the after-sales service terminal 506 located in that county; and if the place is not the same, it determines a location where is close to Hsinchu City, for example, Taichung City or Taipei City and the after-sales service terminal 506 can thereby be chose from the cities.

Please with refer to FIG. 2 which is the first schematic diagram of the first embodiment of an after-sales service communication establishment system according to the present disclosure. The present embodiment takes a television as an example for the product 508. The manufacturer sticks the identification unit 30 on the back of the to-be-shipped product 508, such as a QR Code comprising a network address 501 of the cloud server 20 and the product serial number 502 of the television. When a user operates an image capture module of a cell phone 511 to scan the QR Code, the cell phone 511 can thereby capture the network address 501 installed in the QR Code and connect to the cloud server 20 to download the service program 503 via the network address 501.

Furthermore, when the cell phones 511 connects with the cloud server 20 via the service program 503, the product serial number 502 is transmitted to the cloud server 20 to register the product 508 at the same time, so that it is free from the confusion of inputting registration information step by step via webpage, so as to improve the operation convenience for the user.

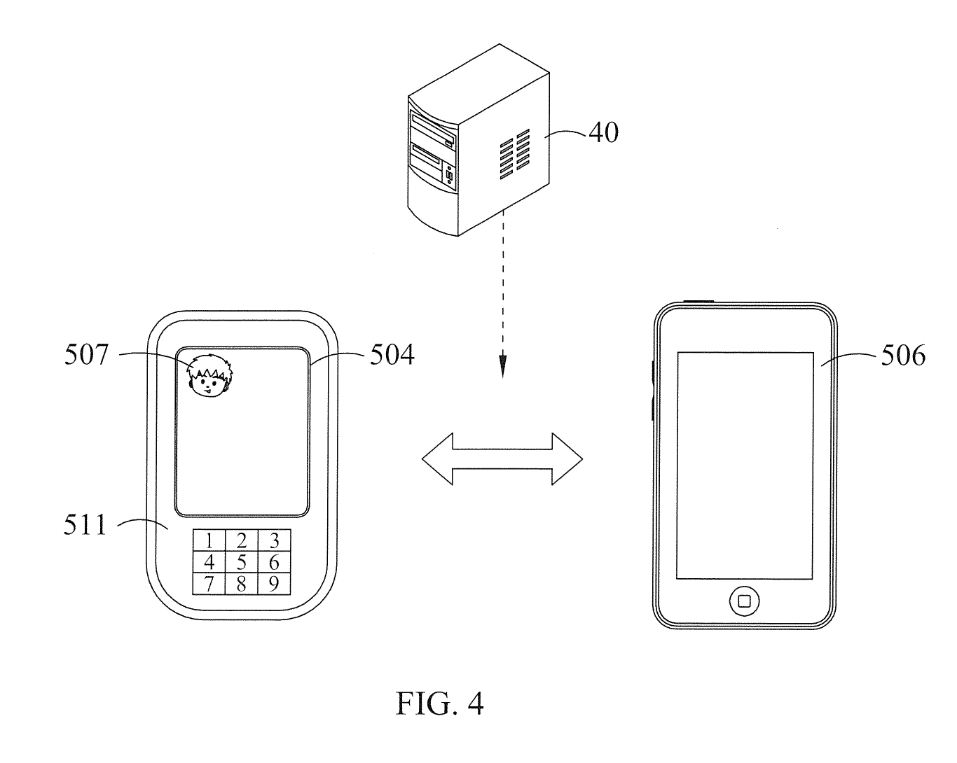

Please with reference to FIG. 3 and FIG. 4 which are second schematic diagram and third schematic diagram of the first embodiment of an after-sales service communication establishment system according to the present disclosure, respectively. As shown in FIG. 3, when the service program 503 is installed in the cell phone 511, the service program 503 generates the shortcut icon 507 on the screen 504 of the mobile device 10, and when the shortcut icon 507 is clicked to execute the service program 503, the cell phone 511 therefore transmits the connection request 510, the product serial number 502 and the id number 505 of the cell phone 511 to the communication establishment server 40.

As shown in FIG. 4, the communication establishment server 40 based on the received product serial number 502 determines the after-sales service terminal 506 which is in charge of the television, and establishes the communication to the after-sales service terminal 506 based on the id number 505. Furthermore, the communication establishment server 40 can establish a consumer toll-free call to connect the cell phone 511 and the after-sales service terminal 506, to service the user more closely.

Apart from being applied to the after-sales service of the product, the system can also be applied to customization application services, such as credit card, EasyCard or other sensing cards. The application of the credit card is taken as an example, when bank issues the credit card, a customized QR Code for the user is established, and the user just operates the cell phone to read the OR Code, and a shortcut icon designed to contact to the professional service personnel is thereby generated on the screen of the cell phone. When the credit card goes with something wrong, the user can directly contact to the professional service personnel by clicking the shortcut icon. Compared with the traditional service contact which needs to be transferred with frequencies, the system of the present disclosure does possess novelty, inventiveness and industrial applicability.

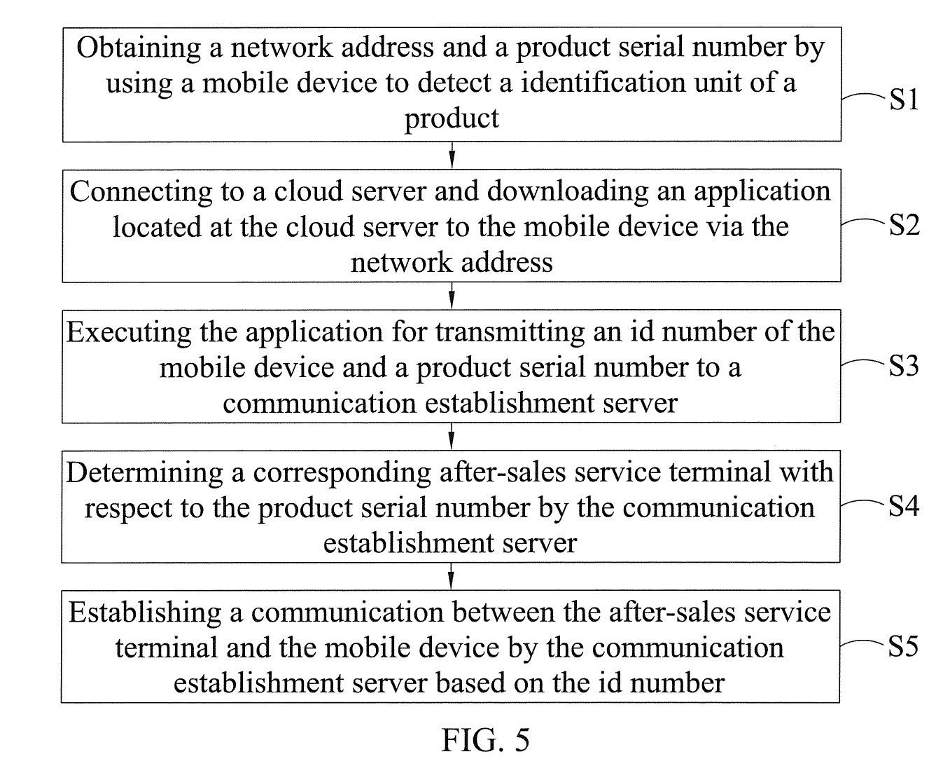

Please with reference with FIG. 5, it is a flow chart of a second embodiment of an after-sales service communication establishment method according to the present disclosure. Step 1 is to obtain a network address and a product serial number by using a mobile device to detect an identification unit of a product. Step 2 is to connect to a cloud server and downloading an application located at the cloud server to the mobile device via the network address. Step 3 is to execute the application for transmitting an id number of the mobile device and a product serial number to a communication establishment server. Step 4 is to determine a corresponding after-sales service terminal with respect to the product serial number by the communication establishment server. Step 5 is to establish a communication between the after-sales service terminal and the mobile device by the communication establishment server based on the id number. More specifically, step 3 to step 5 are the same as the communication established between the user and the after-sales service terminal shown in FIG. 3 and FIG. 4. Therefore, the unnecessary details are no longer given.

In conclusion, in terms of user, professional after-sales service can be obtained promptly without being transferred with frequencies by means of the after-sales service communication establishment method and system thereof, and as far as the firm is concerned, other than reducing the requirement of manpower, it also contributes to the service personnel in shortening the time to respond to client's problem regarding the product, and through the positioning information, the consumer toll-free call service and clicking the shortcut icon, it can also decrease the troublesome steps of saving phone number and can further raise the approval rating along with the satisfaction of after-sales service.

While the means of specific embodiments in present disclosure has been described by reference drawings, numerous modifications and variations could be made thereto by those skilled in the art without departing from the scope and spirit of the invention set forth in the claims. The modifications and variations should in a range limited by the specification of the present disclosure.

What is claimed is:

1. An after-sales service communication establishment method, comprising:
obtaining a network address and a product serial number by using a mobile device to detect an identification unit of the product;
connecting to a cloud server and downloading an application located at the cloud server to the mobile device via the network address;
executing the application for transmitting an id number of the mobile device and the product serial number to a communication establishment server;
determining a corresponding after-sales service terminal with respect to the product serial number by the communication establishment server; and
establishing a communication between the after-sales service terminal and the mobile device by the communication establishment server based on the id number.

2. The after-sales service communication establishment method of claim 1, further comprising steps of:
generating a shortcut icon on a screen of the mobile device when the application is installed in the mobile device; and
clicking the shortcut icon to execute the application.

3. The after-sales service communication establishment method of claim 1, wherein the mobile device comprises positioning information, and the positioning information is transmitted to the communication establishment server and the communication establishment server further determines the after-sales service terminal according to the positioning information.

4. The after-sales service communication establishment method of claim 1, wherein an image of the identification unit is captured and the network address and the product serial number are analyzed by an image capture module of the mobile device, or obtained by sensing the identification unit by a sensing module of the mobile device.

5. The after-sales service communication establishment method of claim 4, wherein the identification unit comprises letters, images, 2D barcodes or QR codes printed or stuck on the product, or NFC sensing chip and RFID chip arranged in the product.

6. The after-sales service communication establishment method of claim 1, wherein the after-sales service terminal is a dedicated line of professional service personnel who is responsible for the product.

7. The after-sales service communication establishment method of claim 6, wherein a communication between the after-sales service terminal and the mobile device is a consumer toll-free call.

8. An after-sales service communication establishment system, comprising:
a cloud server, comprising a service program, and the cloud server providing the application for being downloaded to the mobile device based on a connection request of the mobile device;
a communication establishment server, receiving a communication request, a product serial number of the application installed in the mobile device, and an id number of the mobile device; the communication establishment server determining a corresponding after-sales service terminal with respect to the product serial number and establishing a communication between the mobile device and the after-sales service terminal based on the id number.

9. The after-sales service communication establishment system of claim 8, wherein a shortcut icon is generated on a screen of the mobile device when the application is installed in the mobile device and the application is executed by clicking the shortcut icon.

10. The after-sales service communication establishment system of claim 8, wherein the communication establishment server further receives positioning information transmitted by the mobile device and determines the after-sales service terminal according to the positioning information.
